(19) United States
(12) Patent Application Publication
(10) Pub. No.: US 2021/0048109 A1
(43) Pub. Date: Feb. 18, 2021

(54) GATE VALVE

(71) Applicant: Halliburton Energy Services, Inc., Houston, TX (US)

(72) Inventor: Jim Basuki Surjaatmadja, Duncan, OK (US)

(21) Appl. No.: 16/977,405

(22) PCT Filed: Apr. 18, 2018
(86) PCT No.: PCT/US2018/028309

§ 371 Date: Sep. 1, 2020

(51) Int. Cl. F16K 3/02; F16K 27/04; F16K 3/12; F16K 31/122; F16K 31/60

(52) U.S. Cl. CPC F16K 3/0254; F16K 27/047; F16K 31/60; F16K 31/122; F16K 3/12

(57) ABSTRACT

A gate valve having a valve body defining a flow passage therethrough. The gate valve has a movable gate with an upper and a lower edge for opening and closing the flow passage and a lifting stem extending from the upper edge of the gate configured to move the movable gate between open and closed positions. At balancing stem is configured to offset at least a portion of the force applied to the lifting stem by a fluid flowing through the gate valve when the movable gate is moved between open and closed positions.

### BACKGROUND

Gate valves are well known in the art for use in applications to allow or shut off flow through a pipe component. The gate in a gate valve moves between open and closed positions to selectively open and close a flow passage through the valve. When the gate is between open and closed positions, fluid flowing through the flow passage will impart a force on a lifting stem that is utilized to move the gate between open and closed positions. The fluid passing through the flow passage will impart a force on the lifting stem which can create a force that is high enough such that closing the gate valve is difficult.

### SUMMARY

A gate valve of the current disclosure comprises a valve body with a flow passage therethrough. A gate is movable between open and closed positions in the valve body for selectively opening and closing the flow passage when the gate is moved between open and closed positions. The gate is movable between open and closed positions with a lifting stem that extends from the upper edge of the gate. The gate may comprise at least one balancing stem extending downwardly from a lower edge of the gate. The at least one balancing stem is configured to offset, or counteract at least a portion of the force applied to the lifting stem by fluid flowing through the flow passage when the gate is moving between open and closed positions. A bottom or lower sub is connected to the body and defines at least one channel which may be referred to as an at least one receiving channel receiving the at least one balancing stem.

In one embodiment the gate valve comprises a gate valve body defining a flow passage therethrough with a lifting stem extending from the upper edge of the gate and two balancing stems extending from a lower edge. The cross-sectional area of the two balancing stems may be, for example, substantially equal to the cross-sectional area of the lifting stem. The gate valve may thus comprise a balanced gate valve in which the force applied by fluid flowing through the passage applied to the lifting stem is substantially equal to that applied to the two balancing stems.

In another embodiment of a gate valve, a gate element comprises a wedge-shaped gate element and a shield that covers opposed faces defined by the gate element. The shield will engage a pair of valve seats in the closed position of the gate to block flow through the flow passage.

In another embodiment a gate valve comprises a valve body defining a flow passage therethrough. A pair of valve seats is positioned in the valve body. A gate is movable between open and closed positions in the valve body. In the closed position the gate sealingly engages the valve seats. The lifting stem is attached to an upper edge of the gate and two balancing stems extend from a lower edge of a gate.

In another embodiment a bottom sub is connected to a valve body. The bottom sub has receiving channels defined therein. The balancing stems are received in and are movable in the receiving channels in the bottom sub when the gate moves between open and closed positions. The balancing stems reciprocate in the receiving channels when the gate moves between open and closed positions.

In one embodiment a gate element of the gate valve comprises a wedge-shaped gate with opposite faces that engage a pair of valve seats positioned in the body. The valve seats positioned in the body may be tapered valve seats so that the wedge-shaped gate can sealingly engage the pair of valve seats.

In one embodiment a gate valve comprises a valve body defining a flow passage, a pair of valve seats positioned in the body, and a gate movable between open and closed positions. The gate may comprise a gate element with opposed faces and a shield covering the faces of the gate element wherein the shield engages the valve seats in the closed position of the gate. A lifting stem is connected to the gate for moving the gate between open and closed positions. The gate may further comprise at least one balancing stem extending from the gate. The at least one balancing stem may extend from a lower edge of the gate and the lifting stem may be connected to and extend from an upper edge from the gate.

In one embodiment a cross-sectional area of the at least one balancing stem is substantially equal to or greater than a cross-sectional area of the lifting stem. In another embodiment the at least one balancing stem may have a cross-sectional area less than the cross-sectional area of the lifting stem. The cross-sectional area of the lifting stem may be such that an automatic closing force is applied to the gate. In another embodiment the cross-sectional area of the lifting stem and the at least one balancing stem is such that an opening force is applied to the gate. The opening force is applied when the cross-sectional area of the at least one lifting stem is greater than the cross-sectional area of the balancing stem and the closing force is applied when the cross-sectional area of the balancing stem is greater than the cross-sectional area of the lifting stem.

### BRIEF DESCRIPTION OF THE DRAWINGS

FIG. 1 is a plan view of a gate valve of the current disclosure.

FIG. 2 is a section view perpendicular to the flow through the gate valve in a closed position.

FIG. 3 is a section view identical to the FIG. 2 in the open position.

FIG. 4 is a section view 90° from the view of FIG. 3.

FIG. 5 is section view identical to FIG. 4 in the closed position.

FIG. 6 is a section view of an additional embodiment perpendicular to the flow in a closed position.

FIG. 7 is a section view identical to FIG. 6 in the open position.

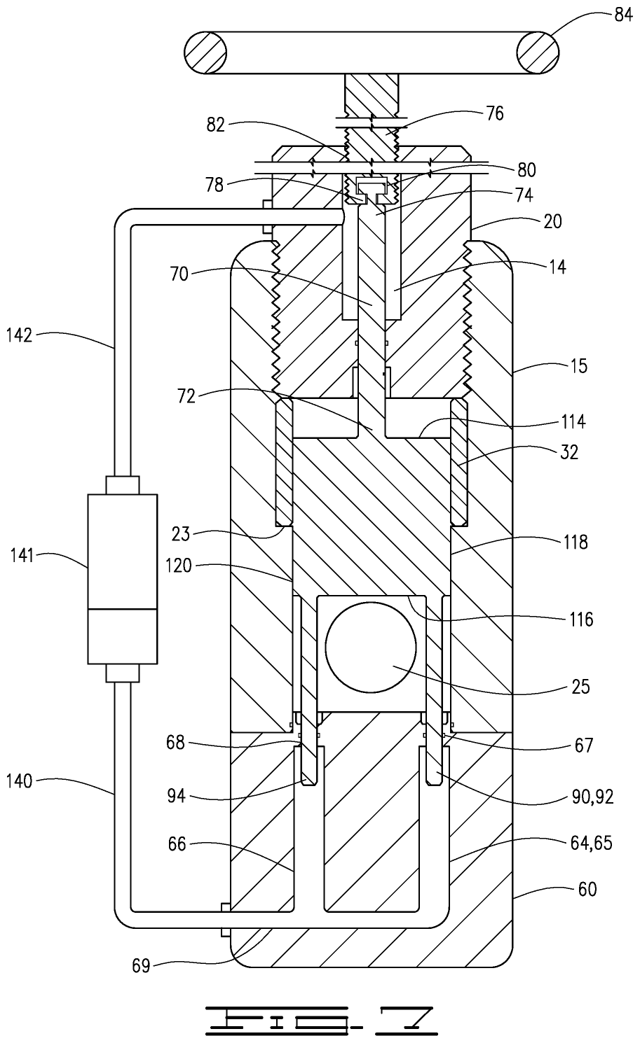

FIG. 8 is a section view 90° from the view of the FIGS. 6 and 7 in the open position.

FIG. 9 is a section view identical to that shown in FIG. 8 in the closed position.

FIG. 10 is a section view showing the gate valve with a pump connected for hydraulic control.

### DESCRIPTION OF EMBODIMENT

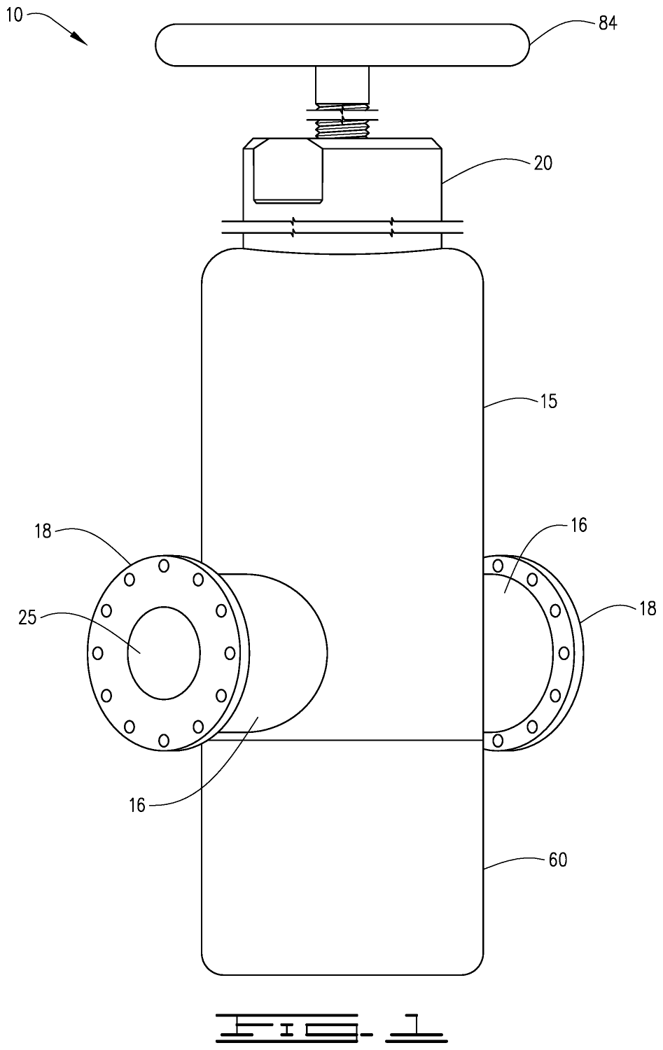

Referring now to the drawings, FIG. 1 is plan view of an exemplary gate valve of the current disclosure. It is understood that other configurations are possible for the gate valve and that the invention described and claimed herein is not limited to the specific configuration shown. Gate valve 10 comprises a valve body 15 connected to a bonnet 20. Bonnet 20 has lower end 21, and body 15 defines an upward-facing shoulder 23. Body 15 defines tubular extensions 16 having flanges 18 thereon. Flanges 18 may be connected to flanges on pipe components to provide fluid to passage 25. The connections to pipe components may be direct thread connections, rapid connection systems, hammer unions that are often used in the oilfield, or other known suitable connections to provide for flow through gate valve 10. A hydraulic port 22 may be defined in the body 15, and communicated with a lifting stem channel 14. In the configuration shown the body 15 is threadedly connected to bonnet 20. However, it is understood that the bonnet 20 may be connected with flanges or may be connected by other means known in the art to body 15. The body 15 defines a flow passage 25 therethrough. A valve seat 26 with a sealing face 27 is positioned in body 15. An opposed valve seat 28 with a sealing face 29 is likewise disposed in body 15. Valve seat 26 has an opening 30 therethrough and valve seat 28 has opening 31 therethrough. Openings 30 and 31 are generally the same size as the bore of flow passage 25 and thus form a portion of passage 25. A spacer 32 is positioned in body 15. A face seal (not shown) around the top and bottom side of spacer 32 can help reduce the parting force of the assembly.

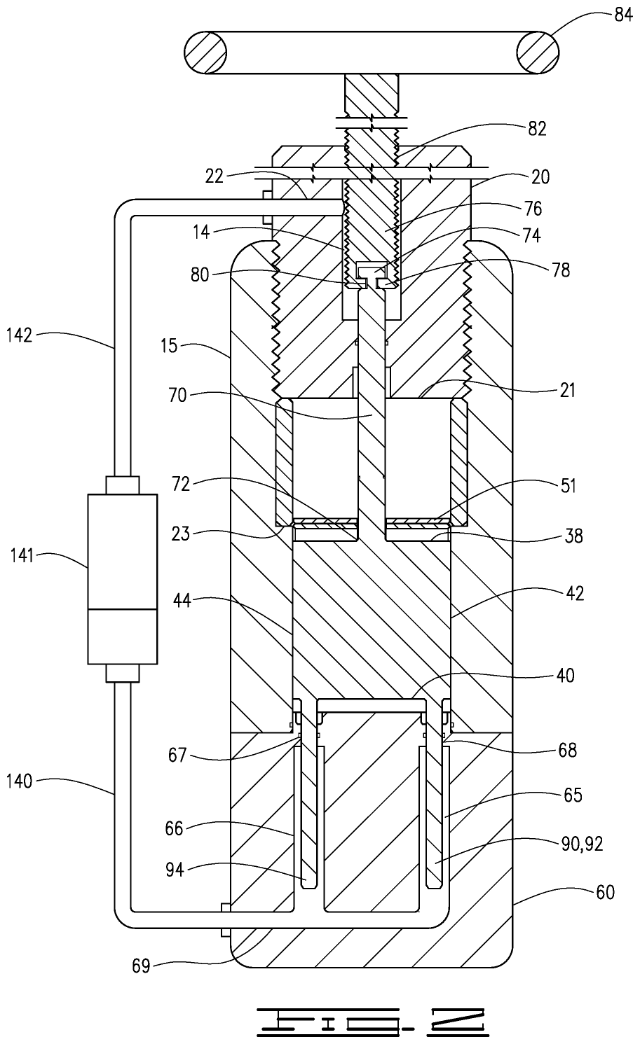

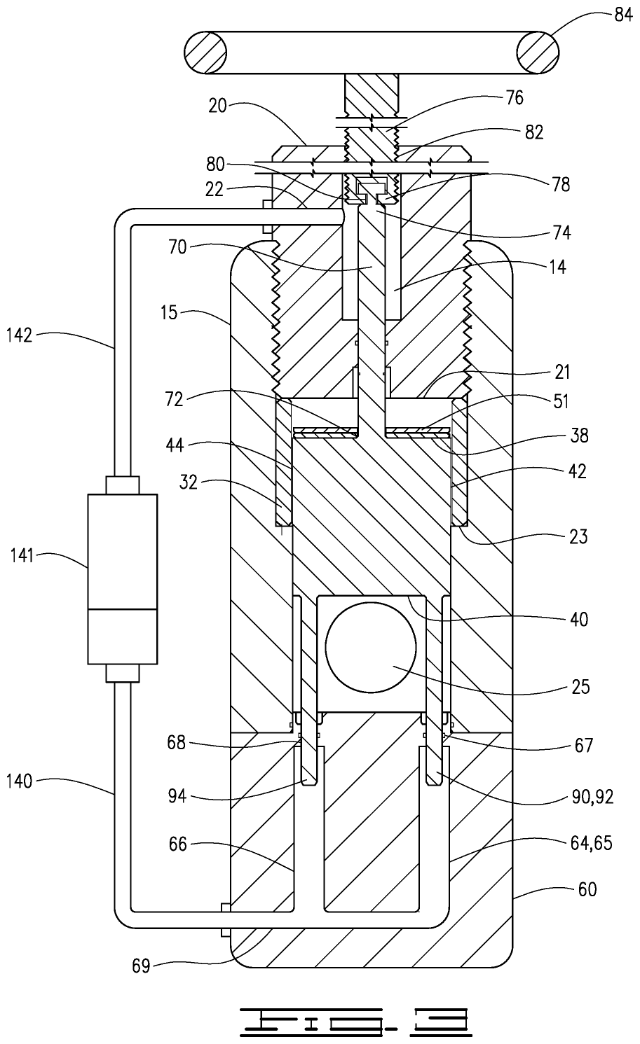

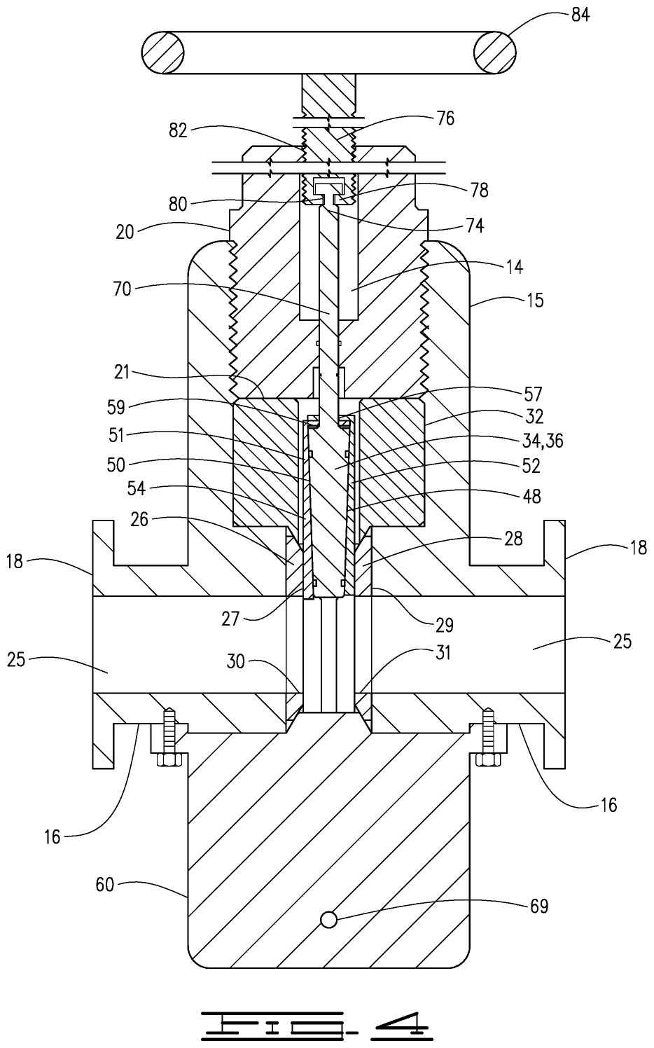

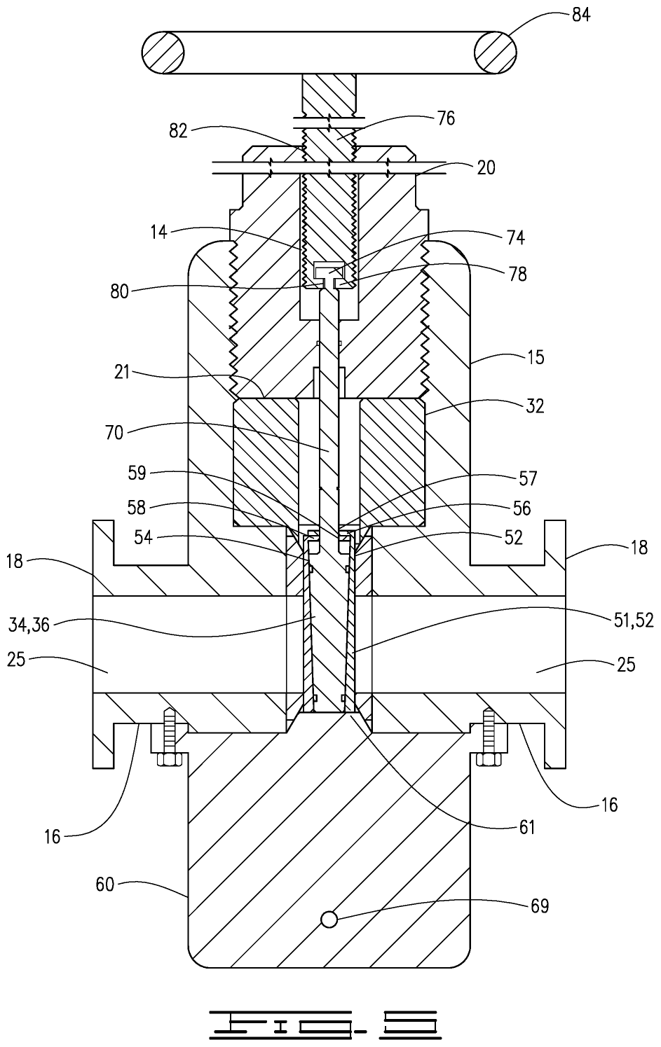

A gate 34 is positioned in body 15 and is configured to move between open and closed positions to selectively open and close flow passage 25. Gate 34 is movable between open and closed positions as shown in FIGS. 2 and 3, respectively. Gate 34 includes gate valve element 36 with upper edge 38, lower edge 40, first side edge 42 and second side edge 44. Gate element 36 has opposed faces which comprise first and second faces 48 and 50, respectively. Gate element 36 is a generally wedge-shaped gate element with tapered faces 48 and 50. In the embodiment of FIGS. 2 through 5, gate 34 includes a shield 51. Shield 51 comprises first and second shield sections 52 and 54 which cover first face 48 and second face 50, respectively. First and second shield sections 52 and 54 have upper connecting legs 56 and 58, respectively with openings 57 and 59 therein. As will be explained in more detail a lifting stem extends through the openings 57 and 59 to mount first and second shield sections 52 and 54 to gate valve element 36. Gate valve element 36 is movable within shield 51. Shield sections 52 and 54 may be pressed tightly between valve seats 28 and 26, respectively, to prevent flow through flow passage 25. As a result the wedge-shaped gate element 36 may fit tightly in shields 52 and 54 as it is pressed downwardly. When pulled upwardly, wedge-shaped gate element 36 can release from the shields 52 and 54 and will engage the legs 56 and 58 thereof to move the gate 34 upwardly.

A bottom sub 60 is connected to body 15 and may be connected to body 15 with bolted flanges. Other connection means such as c-clamps may also be used. A neck 61 may extend upwardly from an upper end of bottom sub 60 and into body 15. Neck 61 may provide a sealed connection between bottom sub 60 and body 15. Elastomeric seals may be added around the neck 61 as necessary.

At least one channel 64 and in the embodiment described two channels 64, which may be referred to as first and second receiving channels 65 and 66, are defined in bottom sub 60. Receiving channels 65 and 66 are configured to receive balancing stems that extend from gate element 36. First and second channels 65 and 66 have narrow portions 67 and 68, respectively. A hydraulic port 69 configured to be connected to a hydraulic line to communicate hydraulic fluid to receiving channels 65 and 66 extends into and is defined in bottom sub 60 and intersects or communicates with both of channels 65 and 66.

A lifting stem 70 is connected at a bottom or first end 72 thereof to upper edge 38 of gate element 36 and extends upwardly. Lifting stem 70 may have a generally circular cross section. An upper or second end 74 of lifting stem 70 is connected to a lifting rod 76. Lifting rod 76 is rotatably connected to lifting stem 70 such that lifting rod 76 can rotate independent of lifting stem 70. Rotation of lifting rod 76 will raise and lower lifting stem 70 thus raising and lowering gate 34 between the open and closed positions. For example as shown in FIG. 2, an upper portion bonnet 20 may have threads 82 thereon and engage threads on lifting rod 76 such that when a wheel or handle 84 is rotated gate 34 moves between open and closed positions. It is understood that there are a number of different configurations that will translate the rotation of the lifting rod 76 into the up and down movement necessary to move the gate 34 and the description herein is not intended to be limiting. In the embodiment shown, a tongue and groove arrangement includes a radially inwardly extending tongue 78 on lifting rod 76 that fits into a groove 80 defined in lifting stem 70. Tongue 78 will be a generally circular ring and will rotate in groove 80. As a result lifting stem 70 will simply move vertically as depicted in the drawings when lifting rod 76 is rotated.

In the embodiment of FIGS. 2-5 shield sections 51 and 52 may drop down or hang freely by their weight and supported by upper edge 38 of gate 34. Other configurations for supporting shield sections 52 and 54 are possible. For example, shield sections 52 and 54 could be forced downward by a spring (not shown). The spring would provide assurance that shield sections 52 and 54 are pressed down and engage upper edge 38. When the shields are down, the gate assembly 34 (gate element 36 and shield 51) can move freely. When the bottom of shield 51 engages lower edge 40 of gate element 36, the gate element 36 will jam shield 51 against seats 26 and 28. The spring (not shown) could for example placed above the shield 51 and held by a ring that can be fastened to lifting stemm 70 using a set screw. The ring could also be a snap ring that resides in a shallow groove positioned in lifting stem 70. To unseat, the gate 34, while pressed hard to valve seats 26 and 28, due to the taper, gate element 36 will pull up easily, while reducing the thickness of the gate assembly 34; thus gate 34 including gate element 36 and shield 51 pulls up easily.

At least one balancing stem 90, and in the embodiment shown two balancing stems 92 and 94 extend from the lower edge 40 of gate element 36. Balancing stems 92 may have a generally circular cross section. First and second balancing stems 92 and 94 extend into receiving channels 65 and 66. Seals 98 in lower sub 60 will sealingly engage balancing stems 92 and 94. Spacer 32 is positioned in body 15 between bottom end 21 of bonnet 20 and shoulder 23 defined on body 15. Spacer 32 may be positioned about gate valve 34 so that the gate valve 34 is movable, and in some cases slidable therein. Spacer 32 defines an opening or space 102 which is configured to provide for the movement of gate 34 between closed and opened positions.

When gate 34 is moving between open and closed positions fluid flowing through passage 25 will impact stem 70. In an additional embodiment a gate valve 110 has features generally identical to gate valve 10 with the exception of the gate configurations, and the configurations on the valve seats. Gate valve 110 comprises gate 112 that includes gate element 113 having upper edge 114, lower edge 116 and first and second side edges 118 and 120. Gate element 113 is a wedge-shaped gate element 113 and does not have a shield. Gate element 113 has sealing surfaces 122 and 124. Gate 112 has lifting stem 70 and at least one balancing stem 90 and in the embodiment shown two balancing stems 92 and 94.

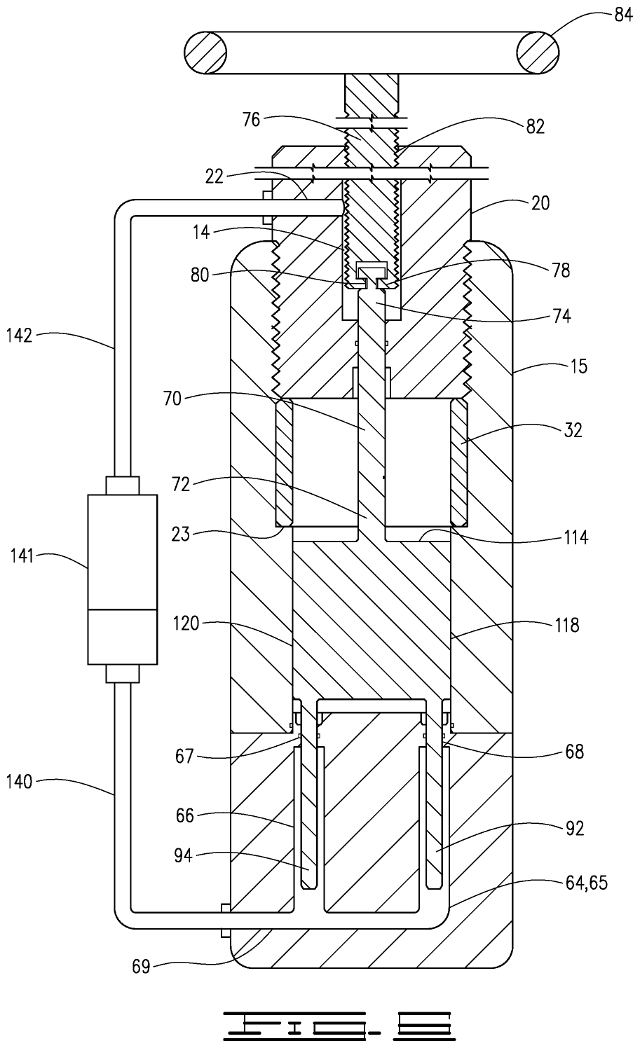

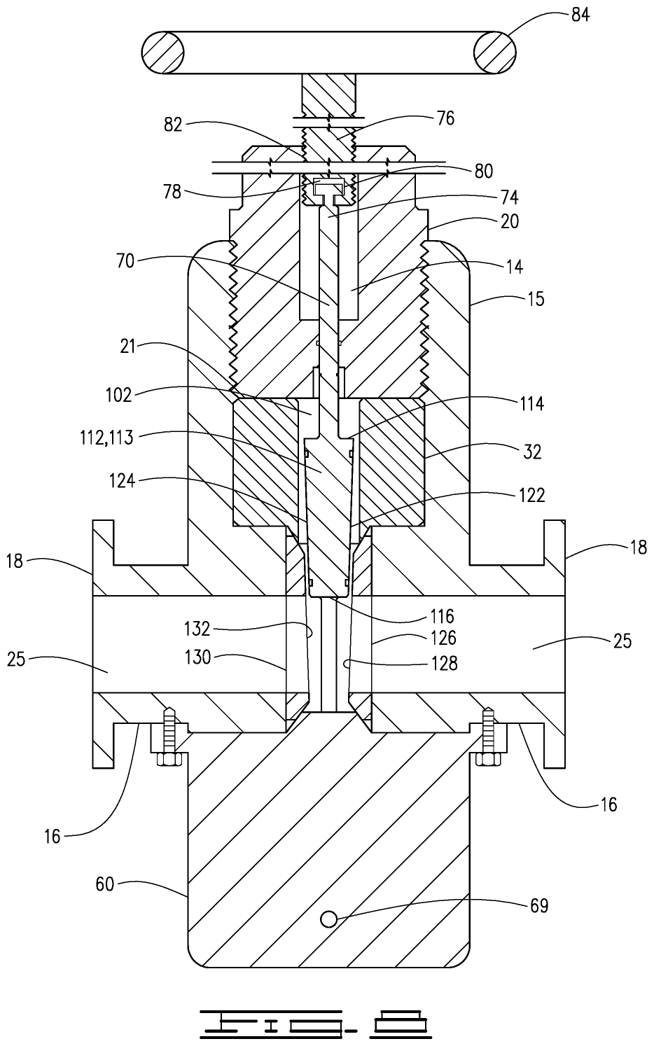

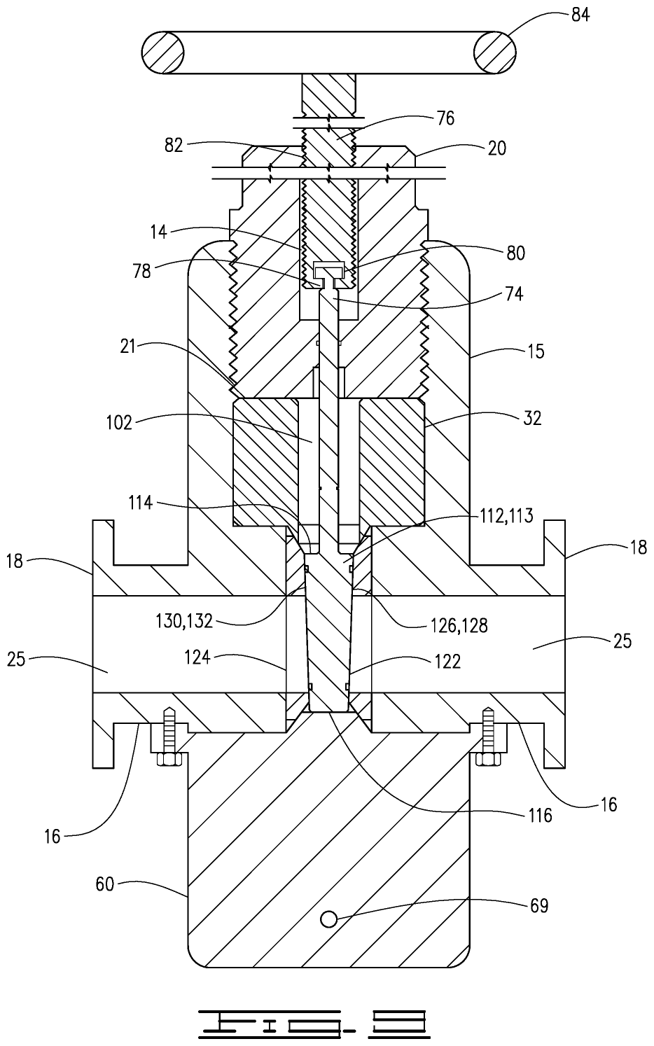

Gate valve 110 has valve seats 126 and 130 with tapered seat faces 128 and 132 for engaging the tapered sealing surfaces 122 and 124 of wedge-shaped gate element 113 as shown in FIGS. 8 and 9. In both embodiments fluid flowing through passage 25 will enter space 102 and will impact the lifting stem 70. A force is applied to lifting stem 70 as a result of the fluid flow. For example at 15,000 psi flow rate with a lifting stem having a diameter of 0.75 inches, the force comprises a push force of approximately 6600 pounds. The applied force may be calculated simply by multiplying the pressure applied (15,000 psi) by the area of the lifting stem which is approximately 0.44 square inches. In order to balance the force the at least one balancing stem has an area substantially equal to that of lifting stem 70. If a single balancing stem 90 is utilized, the diameter of the balancing stem would be identical to that of lifting stem 70. If two balancing stems 92 and 94 are utilized, the diameter of each balancing stem would be approximately 0.5303 inches which would give a substantially equivalent cross-sectional area to the cross-sectional area of a lifting stem having a diameter of 0.75 inches. The diameter of the at least one balancing stem 90 can be slightly greater than the diameter of the lifting stem 70 to create a small positive closing force. In other words, the pressure or force applied by the fluid flowing through passage 25 would impact the balancing stems to urge, or help urge the gate 112 to a closed position. Thus in the embodiment of FIG. 2 the force would move, or assist in moving gate 34 to a closed position and in the embodiment of FIG. 6 gate 112 would similarly be affected and would be moved to the closed position.

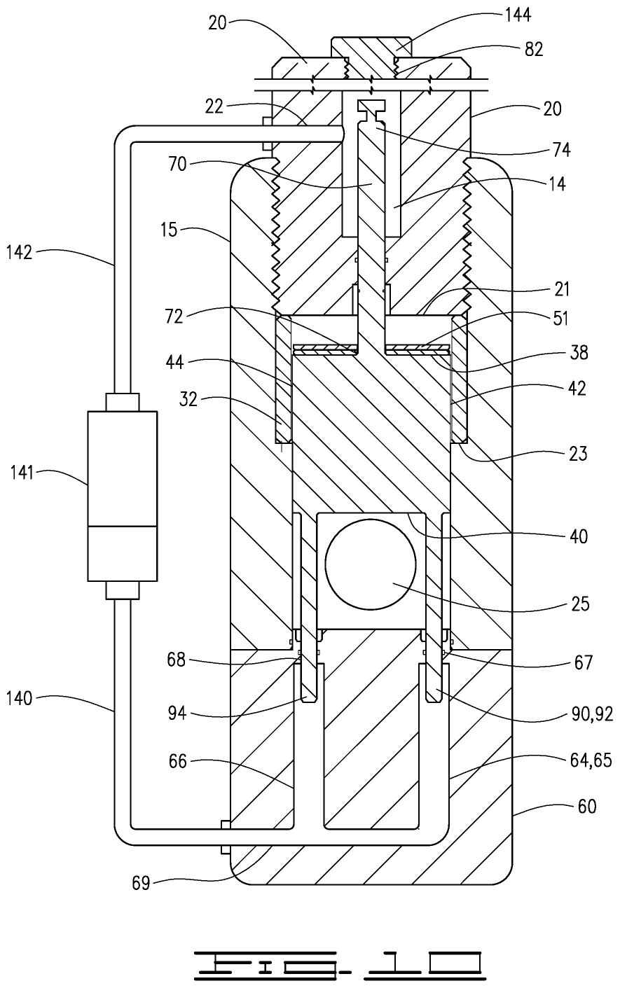

In either embodiment described herein the hydraulic port 69 in bottom sub can be connected to a hydraulic line 140 and then communicated with a hydraulic motor or pump 141. The motor or pump can likewise have a hydraulic line 142 connected to the hydraulic port 22 in bonnet 20. If desired the gate valves of the current disclosure can be automated and moved between open and closed positions by selectively applying hydraulic forces to the hydraulic ports 69 and 22. In the embodiment where pump 141 is connected for hydraulic control use, the manual valve option must be removed and replaced by a cap instead. Thus lifting rod 76 would be removed and a cap would be threaded into bonnet 20 and lifting stem 70 would slide relative to bonnet 20 in response to the applied hydraulic pressure. For example as shown in FIG. 10 a cap, or plug 144 may be threaded into bonnet 20 to close lifting stem channel 20. Stem 70 becomes the actuator, and pushes down by means of the hydraulic pump 141. Upper end 74 of stem 70 in such an embodiment is not connected to other structure and is a free end. Hydraulic pump 141 can either push high pressure to the top side of the gate to close, or the bottom side of the gate to open by generally known valve connections. The configuration of FIG. 10 is shown in the open position where pressure acts to lift the gate. In the configuration where pump 141 is not utilized for hydraulic control, and the gate valve 10 is manually operated with the rotation of wheel 84 and lifting rod 76, slow seepage of liquids from port 22 to port 69 is allowed to slowly balance pressures.

Thus, one embodiment of a gate valve comprises a valve body defining a flow passage therethrough with a gate movable between open and closed positions for selectively allowing or preventing flow through the flow passage. A lifting stem connected to an upper edge of the gate is configured to move the gate between open and closed positions. The gate valve includes at least one balancing stem extending downwardly from the lower edge of the gate. The balancing stem will offset at least a portion of the force applied to the lifting stem by fluid flowing through the gate valve when the gate is moving between open and closed positions.

In one embodiment a cross-sectional area of the at least one balancing stem is substantially the same as the cross-sectional area of the lifting stem so that the force applied to the lifting stem and the at least one balancing stem is substantially the same. In such an embodiment, the forces are balanced such that the gate can be easily opened and closed. If desired, the at least one balancing stem can have a slightly larger cross-sectional area so that it creates an automatic closing force. Likewise, if desired the at least one balancing stem can have a slightly smaller cross-sectional area which will then generate a force such that an automatic opening force is applied.

In an additional embodiment the gate valve has a lower sub which includes at least one receiving channel for receiving the at least one balancing stem. In one embodiment there are two balancing stems and two receiving channels defined in the lower sub for receiving the balancing stems. In another embodiment the gate comprises a wedge-shaped gate element with shields disposed thereabout. The shields have opposed flat sealing surfaces that seal against valve seats to block flow through the flow passageway in the closed position.

In another embodiment the gate valve includes a wedge-shaped element with no shield and tapered valve seats in the valve body. The wedge-shaped valve element will engage the tapered valve seats and will block flow through the flow passage in the closed position.

Thus, it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention.

What is claimed is:

1. A gate valve comprising:
a valve body defining a flow passage therethrough;
a movable gate for selectively opening and closing the flow passage, the gate having an upper edge and a lower edge;
a lifting stem extending from the upper edge of the gate and configured to move the movable gate between open and closed positions; and
at least one balancing stem extending downwardly from the lower edge of the movable gate, the at least one balancing stem configured to offset at least a portion of the force applied to the lifting stem by a fluid flowing through the gate valve when the movable gate is moved between open and closed positions.

2. The gate valve of claim 1, further comprising:
a lower sub connected to the body; and
the lower sub defining at least one receiving channel for receiving the at least one balancing stem.

3. The gate valve of claim 1, the at least one balancing stem having a cross-sectional area at least as large as the cross-sectional area of the lifting stem.

4. The gate valve of claim 1, the at least one balancing stem comprising two balancing stems, wherein the combined cross-sectional area of the balancing stems is substantially equal to or greater than the cross-sectional area of the lifting stem.

5. The gate valve of claim 1, wherein the movable gate comprises:
a wedge shaped gate element defining gate element faces; and
a shield covering the gate element faces, wherein the shield engages a pair of valve seats in the closed position of the gate to block flow through the flow passage.

6. The gate valve of claim 5, wherein the gate is movable in the shield.

7. A gate valve comprising:
a valve body defining a flow passage;
a pair of valve seats positioned in the body;
a gate movable between open and closed positions;
a lifting stem attached to an upper edge of the gate;
at least one balancing stem extending from a bottom edge of the gate; and
a bottom sub defining at least one receiving channel therein, wherein the at least one balancing stem is received in and moves in the at least one receiving channel when the gate moves between open and closed positions.

8. The gate valve of claim 7, wherein the cross-sectional area of the at least one balancing stem is greater than the cross-sectional area of the lifting stem.

9. The gate valve of claim 7 wherein the cross-sectional area of the at least one balancing stem is substantially equal to the cross-sectional area of the lifting stem.

10. The gate valve of claim 7, wherein the at least one balancing stem comprises two balancing stems and the at least one receiving channel comprises two receiving channels.

11. The gate valve of claim 7 wherein the bottom sub defines a receiving channel port communicated with the at least one receiving channel, and wherein a lifting stem port is communicated with a lifting channel defined in the body in which the lifting stem moves, further comprising an actuator configured to direct hydraulic fluid to the lifting stem port and the balancing stem port to move the gate between open and closed positions.

12. The gate valve of claim 7, wherein a force applied to the lifting stem resulting from fluid flow through the passage when the gate is in a partially open position is substantially balanced by a force applied to the at least one balancing stem.

13. The gate valve of claim 7, further comprising a pair of valve seats positioned in the body, the valve seats having tapered seat faces, the gate comprising a wedge-shaped valve element for sealingly engaging the valve seats in the closed position of the gate.

14. A gate valve comprising:
a valve body defining a flow passage;
a pair of valve seats positioned in the valve body;
a gate movable between open and closed positions, the gate comprising a gate element defining opposed faces;
a shield covering the opposed faces of the gate element, the shield being configured to engage the valve seats in the closed position of the gate; and
a lifting stem connected to the gate for moving the gate between the open and closed positions.

15. The gate valve of claim 14 further comprising at least one balancing stem extending from a lower edge of the gate.

16. The gate valve of claim 15, wherein the at least one balancing stem comprises two balancing stems.

17. The gate valve of claim 15 further comprising a bottom sub connected to the valve body defining at least one receiving channel configured to receive the at least one balancing stem.

18. The gate valve of claim 15, wherein a cross-sectional area of the at least one balancing stem is substantially equal to or greater than a cross-sectional area of the lifting stem.

19. The gate valve of claim 14 further comprising a balancing stem extending from a lower edge of the gate, the balancing stem configured to counteract at least a portion of the force applied to the lifting stem by fluid flowing through the body as the gate moves between open and closed positions.

20. The gate valve of claim 19 wherein the balancing stem is configured to substantially balance the force applied to the lifting stem by fluid flowing through the body as the gate is moved between open and closed positions.
